(19) United States
(12) Patent Application Publication
(10) Pub. No.: US 2003/0228091 A1
(43) Pub. Date: Dec. 11, 2003

(54) Wavelength selector to be used in wavelength divison multiplexing networks

(76) Inventors: Jong-moo Lee, Daejeon (KR); Joon-tae Ahn, Daejeon (KR); Doo-hee Cho, Daejeon (KR); Sun-tak Park, Kyungki-do (KR); Myung-hyun Lee, Daejeon (KR); Kyong-hon Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/292,313

(22) Filed: Nov. 12, 2002

(30) Foreign Application Priority Data
Jun. 5, 2002 (KR) 2002-31591

(51) Int. Cl. G02B 6/26

(52) U.S. Cl. 385/18

(57) ABSTRACT

A wavelength selector to be used in WDM networks is provided. The wavelength selector is composed of a circulator, an arrayed waveguide grating (AWG), which is used for wavelength demultiplexing and multiplexing part, and an electro-optical (EO) switching part. The input light after the circulator is demultiplexed through the AWG part and each channel of the demultiplexed lights is modulated and reflected through the EO switching part which is formed as Michelson type interferometer with mirror parts returning the light to the AWG. The modulated and reflected light is multiplexed through the AWG and the direction is changed to the output through the circulator.

### BACKGROUND OF THE INVENTION

1. Field of the Invention

The present invention relates to a wavelength selector to be used in wavelength-division multiplexing (WDM) networks, and more particularly, to a wavelength selector to be used in WDM networks using an electro-optic (EO) switch.

2. Description of the Related Art

FIG. 1 illustrates an example of a conventional wavelength selector to be used in WDM networks. Referring to FIG. 1, the conventional wavelength selector 100 to be used in WDM networks includes a demultiplexing part 110, an optical switching part 120, and a multiplexing part 130.

The wavelength demultiplexing part 110 has a structure in which a demuplexer 114 comprised of an arrayed waveguide grating (AWG) is formed on a substrate 112. The AWG is formed of silica, polymer, or a semiconductor material. The demultiplexer 114 demultiplexes light IN input from an input waveguide into light of each wavelength such as λ₁, λ₂, λ₃, . . . , λₙ₋₁, and λₙ, and outputs the light of the wavelengths to output waveguides.

The optical switching part 120 has a structure in which a number N of semiconductor optical amplifiers (SOA) 124 are formed on a substrate 122. Each of the optical amplifiers 124 is connected to each output waveguide of the demultiplexer 114. Light of predetermined wavelength selected from different wavelengths such as λ₁, λ₂, λ₃, . . . , λₙ₋₁, and λₙ, output by the demultiplexer 114 passes through the SOA 124, and light of the other wavelengths does not pass through the SOA 124.

The wavelength multiplexing part 130 has a structure in which a multiplexer 134 comprised of an AWG is formed on a substrate 132. The AWG is formed of one of silica, polymer, or semiconductor materials. The multiplexer 134 outputs light to an output light OUT of a predetermined wavelength λₖ selected by the SOA 124.

The wavelength selector comprised of the wavelength demultiplexing part 110, the optical switching part 120, and the wavelength multiplexing part 130 includes a monolithic structure and a hybrid structure. The wavelength selector having a monolithic structure includes the wavelength demultiplexing part 110, the optical switching part 120, the wavelength multiplexing part 130 that are formed on a single substrate, i.e., on an InP (as a semiconductor material) substrate or polymer which can be electro-optically modulated. The wavelength selector having a hybrid structure includes the wavelength demultiplexing part 110, the optical switching part 120, and the wavelength multiplexing part 130 that are formed on a separate substrate and bonded to one another.

It is advantageous that a wavelength selector of a monolithic structure is implemented by forming the SOA on the InP substrate, but the wavelength selector having a monolithic structure has a problem of complex fabrication processes and its high cost.

Polymer material can be used also for the wavelength selector with a merit of simple fabrication process. Polymer materials for EO modulation, however, have a problem of very high propagation loss. So, it is desirable to compose a wavelength selector as a hybrid structure, in case of polymeric device. The wavelength demultiplexing part 110 and the wavelength multiplexing part 130 are formed on a substrate with a low optical loss in case of the wavelength selector of a hybrid structure. A problem for the hybrid structure is that an attachment process in which the wavelength demultiplexing part 110, the optical switching part 120, and the wavelength multiplexing part 130 should be aligned with one another and attached to one another, should be added to a fabrication process of the wavelength selector. This attachment process is a critical factor increasing the cost of product since it is usually performed using a high-priced aligning machine at quite a long process time. And the demultiplexer and the multiplexer should have the same characteristics in distributing the wavelength since there should be a critical loss and crosstalk if their characteristics are different. So, the couple of AWG should be chosen with a great care and should be tuned with a highly sensitive temperature controller so as for the couple of AWG operated with the same characteristics for the wavelengths.

### SUMMARY OF THE INVENTION

It is an objective of the present invention to provide a wavelength selector of a hybrid structure with a reduced attachment process and to overcome the complexity in tuning the couple of AWG with each other by using only one AWG.

The wavelength selector includes an input, a wavelength demultiplexing part coupled to the input, which demultiplexes input light or distributes the lights as the wavelengths and outputs a plurality of output light of each wavelength, and an optical switching part including an electro-optic (EO) switch which transmits the plurality of output light from the wavelength demultiplexing part, and a mirror that reflects light transmitted from the EO switch to the opposite direction and selects the light of predetermined wavelengths by Michelson-type interferometry using the interference between the couple of light reflected from the couple of mirror.

The input includes an input optical waveguide connected to WDM networks, from which the light is input, a transmission optical waveguide which transmits the light to the wavelength demultiplexing part and transmits the light after the reflection to the opposite direction, and a circulator including an output optical waveguide which outputs the light after the wavelength selection.

It is also preferable that the wavelength demultiplexing part, connected to the input, outputs a plurality of light of different wavelengths through a plurality of optical waveguides and that a thermo-optic switch is to be connected to the optical waveguides to which the plurality of light is output.

It is also preferable that the EO switch of the optical switching part is formed in an electro-optic (EO) polymer layer.

It is also preferable that the EO switch includes a first optical waveguide, and a second optical waveguide whose refractive index is varied depending on bias voltage applied to it.

### BRIEF DESCRIPTION OF THE DRAWINGS

The above objects and advantages of the present invention will become more apparent by describing the preferred embodiments with reference to the attached drawings in which:

FIG. 1 illustrates an example of a conventional wavelength selector to be used in WDM networks;

FIG. 2 illustrates a wavelength selector to be used in WDM networks, using an electro-optic (EO) switch;

FIG. 3 is a cross-sectional view taken along line III-III of FIG. 2; and

FIG. 4 illustrates a wavelength selector to be used in wavelength division multiplexed networks according to the present invention.

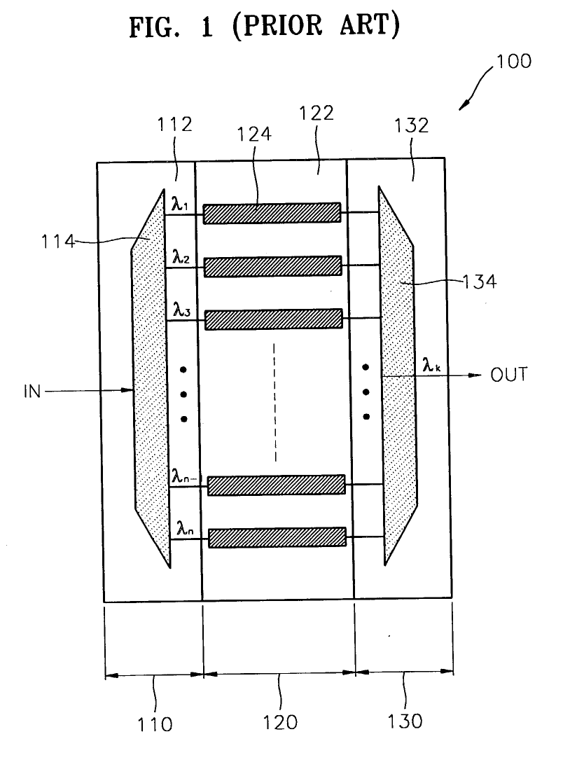

### DETAILED DESCRIPTION OF THE INVENTION

The present invention will be described in detail with reference to the accompanying drawings in which preferred embodiments of the invention are shown. This invention may, however, be embodied in many different forms and should not be limited to the embodiments set forth herein.

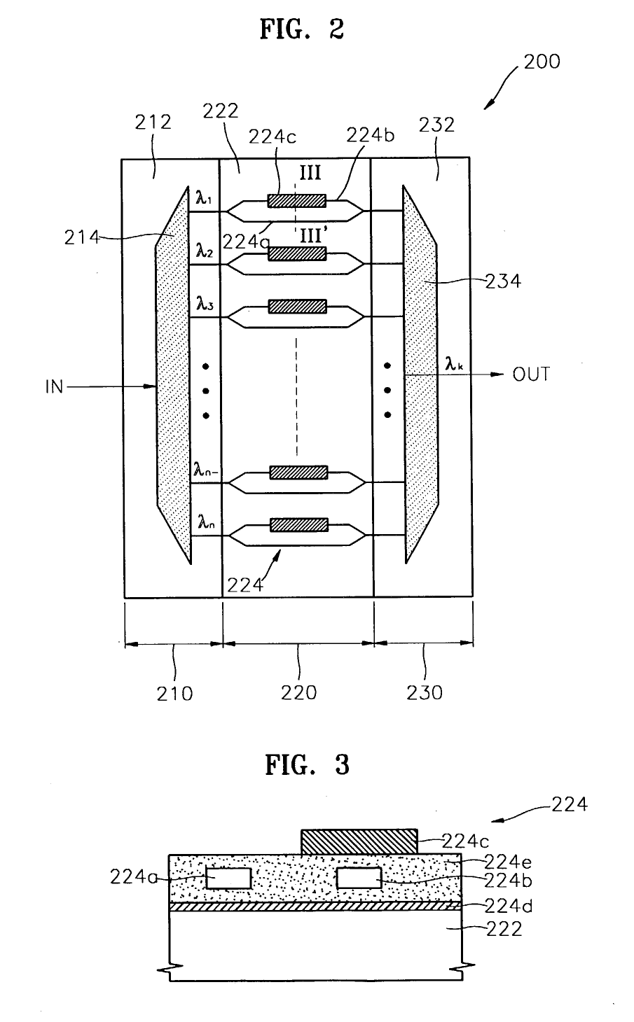

FIG. 2 illustrates a wavelength selector to be used in WDM networks, using an electro-optic (EO) switch, and FIG. 3 is a cross-sectional view taken along line III-III of FIG. 2.

Referring to FIG. 2, the wavelength selector 200 to be used in WDM networks, using an electro-optic (EO) switch includes a wavelength demultiplexing part 210, an optical switching part 220, and a wavelength multiplexing part 230.

The wavelength demultiplexing part 210 has a structure in which a demuplexer 214 comprised of an arrayed waveguide grating (AWG) formed of polymer with little loss is formed on a substrate 212. The demultiplexer 214 demultiplexes light IN incident from an input waveguide into light having different wavelengths such as λ₁, λ₂, λ₃, . . . , λₙ₋₁, and λₙ, and outputs the light having the wavelengths to output waveguides.

The optical switching part 220 has a structure in which a number N of electro-optic (EO) switches 224 are formed on a substrate 222. As shown in FIG. 3, each of the EO switches 224 is comprised of a first optical waveguide 224a, a second optical waveguide 224b, an upper electrode 224c, a lower electrode 224d, and a polymer cladding layer 224e. The first optical waveguide 224a and the second optical waveguide 224b are formed on the polymer layer 224e on the substrate 222. The lower electrode 224d is disposed between the polymer cladding layer 224e and the substrate 222. The upper electrode 224c overlaps only with the second optical waveguide 224b on the polymer cladding layer 224e. The second optical waveguide 224b which overlaps with the upper electrode 224c is formed of an electro-optic (EO) material whose refractive index can be varied depending on an applied bias voltage. The first optical waveguide 224a which does not overlap with the upper electrode 224c may be also formed of an electro-optic (EO) material.

The EO switches 224 constitute a Mach-Zehnder type interferometry. That is, each light having different wavelengths such as λ₁, λ₂, λ₃, . . . , λₙ₋₁, and λₙ, output from the demultiplexer 214 is transmitted through the first optical waveguide 224a and the second optical waveguide 224b of each of the EO switches 224 by a predetermined mirror system. In this case, the existence of a phase difference between light passing through the first optical waveguide 224a and light passing through the second optical waveguide 224b is determined depending on whether a bias voltage is applied between the upper electrode 224c and the lower electrode 224d of the EO switches 224. If there is a phase difference of π or odd multiple of π between the light passing through the first optical waveguide 224a and the light passing through the second optical waveguide 224b, the light is radiated by destructive interference. On the contrary, if there is no phase difference between the light passing through the first optical waveguide 224a and the light passing through the second optical waveguide 224b or there is a phase difference of even multiple of π between the light passing through the first optical waveguide 224a and the light passing through the second optical waveguide 224b, the light is transmitted to the next stage by the constructive interference.

The wavelength multiplexing part 230 has a structure in which a multiplexer 234 comprised of an arrayed waveguide grating (AWG) is formed on a substrate 232. The multiplexer 234 outputs light having a predetermined wavelength λₖ selected by the EO switches 222 to the output light OUT.

Even though the EO switches 224 show very fast switching speed due to transmission speed in units of several ns, an attachment process among the wavelength demultiplexing part 210, the optical switching part 220, and the wavelength multiplexing part 230 is still required. In addition, the waveguide with the EO polymer material shows a optical loss as high as several (2 to 3) dB/cm while the length of the EO switches 224 should be more than several cm.

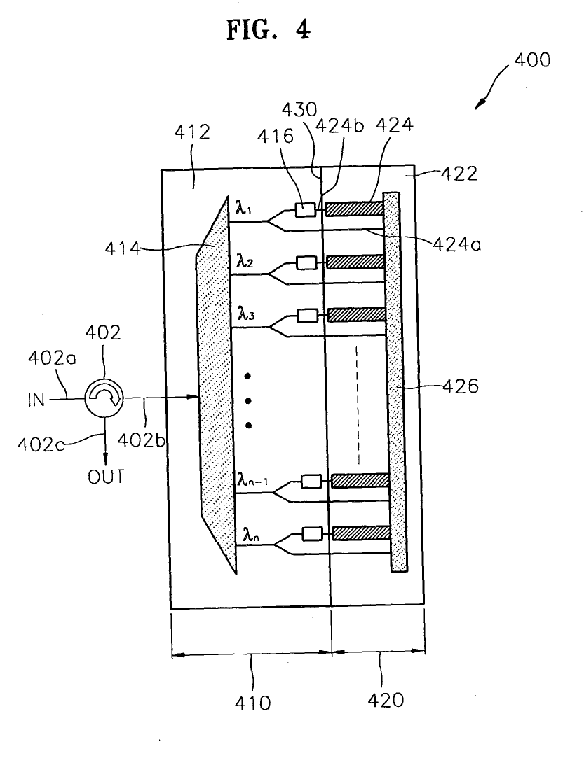

FIG. 4 illustrates a wavelength selector to be used in WDM networks according to the present invention. Referring to FIG. 4, the wavelength selector 400 according to the present invention can be connected to WDM networks. The input light IN from the WDM networks is transferred to the circulator 402 through an input optical waveguide 402a. The circulator 402 is connected to a wavelength demultiplexing part 410 and a transmission optical waveguide 402b.

The wavelength demultiplexing part 410 has a structure in which a demultiplexer 414 comprised of an arrayed waveguide grating (AWG) is formed on a substrate 412. The demultiplexer 414 distributes the input light IN from the circulator 402 separately as the wavelengths such as λ₁, λ₂, λ₃, . . . , λₙ₋₁, and λₙ, and transfers the light of the each wavelength to output waveguides.

Each light of different wavelengths such as λ₁, λ₂, λ₃, . . . , λₙ₋₁, and λₙ, and λₙ, from the demultiplexer 414 is branched into a couple of optical waveguides 424a and 424b and is transmitted to the optical switching part 420.

The optical switching part 420 has a structure in which a number N of electro-optic (EO) switches 424 are formed on a substrate 422. Each of the EO switches 424 is comprised of the first optical waveguide 424a, the second optical waveguide 424b, and the upper electrode 424c. Each of the EO switches 424 further includes a lower electrode (not shown) and a polymer cladding layer (not shown). The upper electrode 424c overlaps only with the second optical waveguide 424b. The second optical waveguide 424b which overlaps with the upper electrode 424c is formed of an electro-optic (EO) material whose refractive index can be varied depending on the bias voltage applied to it. The first optical waveguide 424a which does not overlap with the upper electrode 424c is formed with the same material. Both the first optical waveguide 424a and the second optical waveguide 424b are connected to a mirror 426 that is vertically disposed. The mirror 426 can be formed by coating a metal layer after providing a vertical facet, on which a mirror is to be formed, by etching.

The EO switches 424 constitute a Michelson type interferometry so as for the length of the EO switches 424 to be relatively minimized. That is, each light having different wavelengths such as λ₁, λ₂, λ₃, . . . , λₙ₋₁, and λₙ,output from the demultiplexer 414 is branched into the first optical waveguide 424a and the second optical waveguide 424b and is transmitted to the optical switching part 420. Each transmitted light is reflected from the mirror 426 and is returned to the opposite direction through each optical waveguide 424a and 424b. In this case, the magnitude of a phase difference between the light passing through the first optical waveguide 424a and the light passing through the second optical waveguide 424b is determined depending on whether a bias voltage is applied to the upper electrode 424c. The light returned after reflection through the first optical waveguide 424a and that through the second optical waveguide 424b interferes at the joining part. As a result of the interference, only the light of selected wavelength is returned to the demultiplexer 414 of the wavelength demultiplexing part 410. In this case, the demultiplexer 414 serves as a multiplexer and the light through it is transferred to the output through the output optical waveguide 402c of the circulator 402.

An electrode 416 for phase error correction is disposed on the second optical waveguide 424b in the wavelength demultiplexing part 410 adjacent to the optical switching part 420. Phase errors may occur between the first optical waveguide 424a and the second optical waveguide 424b in the wavelength demultiplexing part 410 and between the first optical waveguide 424a and the second optical waveguide 424b in the optical switching part 420. The phase errors may occur after the attachment process of the wavelength demultiplexing part 410 and the optical switching part 420. When the phase errors occur, the phase errors can be corrected by the electrode 416 for phase error correction. That is, the phase errors are corrected by applying a bias voltage inducing a thermo-optic modulation in which the refractive index of the material is varied due to heat caused by the applied bias voltage.

The optical waveguide of the wavelength demultiplexing part 410 is formed in a polymer layer with little loss, and the optical waveguide of the optical switching part 420 is formed in an electro-optic (EO) polymer layer. It is well known that an optical loss of the electro-optic (EO) polymer material is as high as 10 times of that of the passive polymer material forming passive devices or thermo-optic switches. Accordingly, in order to reduce the total optical loss of the wavelength selector 400, the least portion of the optical waveguide for electro-optic (EO) switching operation is formed with the electro-optic (EO) polymer material, and the other part of optical waveguide is formed with the passive polymer material of a low loss.

As described above, the wavelength selector to be used in WDM networks according to the present invention has the following advantages.

First, the length of each of the electro-optic (EO) switches can be reduced by implementing the optical switching part as a Michelson type interferometry, and thus switching speed is improved by the decrease in the electric capacitance with the short length.

Second, the electro-optic (EO) polymer layer with a relatively high optical loss is used by the least length in forming the electro-optic (EO) switches, and thus a total optical loss of the wavelength selector can be reduced.

Third, only one relatively high-priced arrayed waveguide grating (AWG) is used, and thus the attachment point is decreased compared with that case using a couple of AWG. It can decrease the process time for the attachments, and thus manufacturing costs can be reduced.

Fourth, It is not necessary to tune the wavelength property of AWG as in the case of previous techniques using a couple of AWG s in which the wavelength property should be tuned with each other. So, the selection of operation of AWG is much more simple.

Fifth, the phase errors which can occur when the wavelength demultiplexing part is attached to the optical switching part, are corrected by the thermo-optic modulation, and thus the reliability of the wavelength selector can be improved.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A wavelength selector comprising:
an input;
a wavelength demultiplexing part coupled to the input, demultiplexing input light or distributing the lights as the wavelengths, and outputting a plurality of output light of each wavelength; and
an optical switching part including an electro-optic (EO) switch which transmits the plurality of output light from the wavelength demultiplexing part; and
a mirror that reflects light transmitted from the EO switch to the opposite direction and selects the light of predetermined wavelengths by Michelson-type interferometry using the interference between the couple of light reflected from the couple of mirror.

2. The wavelength selector of claim 1, wherein the input includes an input optical waveguide connected to WDM networks, from which the light is inputted, a transmission optical waveguide which transmits the light to the wavelength demultiplexing part and transmits the light after the reflection to the opposite direction, and a circulator including an output optical waveguide which outputs the light after the wavelength selection.

3. The wavelength selector of claim 1, wherein the wavelength demultiplexing part comprises:
a demultiplexer, the demultiplexer being connected to the input and outputting a plurality of light of different wavelengths through a plurality of optical waveguides; and
a thermo-optic switch being connected to the optical waveguides to which the plurality of light is output.

4. The wavelength selector of claim 3, wherein the thermo-optic switch is formed with polymer material of a low loss.

5. The wavelength selector of claim 1, wherein the EO switch of the optical switching part is formed with electro-optic (EO) polymer material.

6. The wavelength selector of claim 1, wherein the EO switch comprises:
a couple of optical waveguide the refractive index of one of which is varied depending on bias voltage applied.
